(19) United States
(12) Patent Application Publication
(10) Pub. No.: US 2026/0066285 A1
(43) Pub. Date: Mar. 5, 2026

(54) POWER STORAGE DEVICE

(71) Applicants: ENEOS Corporation, Chiyoda-ku, Tokyo (JP); Kyoto University, Kyoto-shi, Kyoto (JP)

(72) Inventors: Tomomi NAGATSUKA, Chiyoda-ku, Tokyo (JP); Hirofumi TAKAMI, Chiyoda-ku, Tokyo (JP); Yasushi SATO, Chiyoda-ku, Tokyo (JP); Takeshi ABE, Kyoto-shi, Kyoto (JP); Kohei MIYAZAKI, Kyoto-shi, Kyoto (JP); Yuto MIYAHARA, Kyoto-shi, Kyoto (JP); Akari IWASAKI, Kyoto-shi, Kyoto (JP)

(73) Assignees: ENEOS Corporation, Chiyoda-ku, Tokyo (JP); Kyoto University, Kyoto-shi, Kyoto (JP)

(21) Appl. No.: 19/106,674

(22) PCT Filed: Aug. 21, 2023
(86) PCT No.: PCT/JP2023/029964

§ 371 Date: Feb. 26, 2025

(30) Foreign Application Priority Data
Aug. 29, 2022 (JP) 2022-136102

(51) Int. Cl. H01M 4/50; H01M 4/02; H01M 4/24

(52) U.S. Cl. CPC H01M 4/50; H01M 4/244; H01M 2004/027; H01M 2004/028

(57) ABSTRACT

A power storage device includes: a positive electrode that contains manganese dioxide; a negative electrode that contains zinc; a positive electrolyte in contact with the positive electrode; a negative electrolyte in contact with the negative electrode; and an anion exchange membrane that separates the positive electrode and the positive electrolyte from the negative electrode and the negative electrolyte. The anion exchange membrane has a zinc ion permeation rate of less than 15.6×10-6 [mol/cm2/24 hrs] and a membrane resistance of less than 12.3 [Ω·cm2].

### CROSS-REFERENCE TO RELATED APPLICATIONS

This application is based upon and claims the benefit of priority from the prior Japanese Patent Application No. 2022-136102, filed on Aug. 29, 2022, and the International Patent Application No. PCT/JP2023/029964, filed on Aug. 21, 2023, the entire content of each of which is incorporated herein by reference.

### BACKGROUND

### Field of the Invention

The present invention relates to a power storage device.

### Description of the Related Art

As an alternative to lithium ion secondary batteries, which are widely used as power storage devices, the development of zinc-manganese dioxide (Zn—MnO₂) secondary batteries has been studied for a long time (see, for example, Patent Literature 1).

Patent Literature 1: JP 2016-501425 (published Japanese translation of PCT international publication for patent application)

### SUMMARY OF THE INVENTION

It is known that irreversible reactions occur at a positive electrode in power storage devices containing zinc in a negative electrode and manganese dioxide in the positive electrode, such as zinc-manganese dioxide secondary batteries. For this reason, it has been difficult to obtain a sufficient life, in other words, a sufficient cycle characteristic.

The present invention has been made in view of such a situation, and an object thereof is to provide a technique for improving the cycle characteristic of a power storage device.

One embodiment of the present invention relates to a power storage device. This power storage device includes: a positive electrode that contains manganese dioxide; a negative electrode that contains zinc; a positive electrolyte in contact with the positive electrode; a negative electrolyte in contact with the negative electrode; and an anion exchange membrane that separates the positive electrode and the positive electrolyte from the negative electrode and the negative electrolyte, wherein the anion exchange membrane has a zinc ion permeation rate of less than 15.6×10⁻⁶ [mol/cm²/24 hrs] and a membrane resistance of less than 12.3 [Ω·cm²].

Optional combinations of the aforementioned constituting elements, and implementations of the present disclosure in the form of methods, apparatuses, and systems may also be practiced as additional modes of the present disclosure.

### BRIEF DESCRIPTION OF DRAWINGS

Embodiments will now be described, by way of example only, with reference to the accompanying drawings which are meant to be exemplary, not limiting, and wherein like elements are numbered alike in several Figures, in which:

FIG. 1 is a schematic diagram of a power storage device according to an embodiment.

FIG. 2 is a diagram showing results of electrochemical measurement of a power storage device according to each of exemplary embodiments and comparative examples.

FIG. 3 is a diagram showing results of electrochemical measurement of a power storage device according to each of exemplary embodiments and comparative examples.

FIG. 4 is a diagram showing results of structural analysis of a power storage device according to the first exemplary embodiment and the first comparative example.

### DETAILED DESCRIPTION OF THE INVENTION

Hereinafter, the present invention will be described based on preferred embodiments with reference to the drawings. The embodiments do not limit the technical scope of the present invention and are shown for illustrative purposes, and not all the features described in the embodiments and combinations thereof are necessarily essential to the invention. Therefore, regarding the details of the embodiments, many design modifications such as change, addition, deletion, etc., of the constituent elements may be made without departing from the spirit of the invention defined in the claims. New embodiments resulting from added design change will provide the advantages of the embodiments and variations that are combined.

In the embodiments, the details for which such design change is possible are emphasized with the notations “according to the present embodiment,” “in the present embodiment,” etc. However, design change is also allowed for those without such notations. Optional combinations of the constituting elements described in the embodiments are also valid as embodiments of the present invention. The same or equivalent constituting elements, members, and processes illustrated in each drawing shall be denoted by the same reference numerals, and duplicative explanations will be omitted appropriately. The scales and shapes of parts shown in each figure are set for the sake of convenience in order to facilitate the explanation and shall not be interpreted in a limited manner unless otherwise mentioned. Terms like “first,” “second,” etc., used in the specification and claims do not indicate an order or importance by any means and are used to distinguish a certain feature from the others. Some of the components in each figure may be omitted if they are not important for explanation.

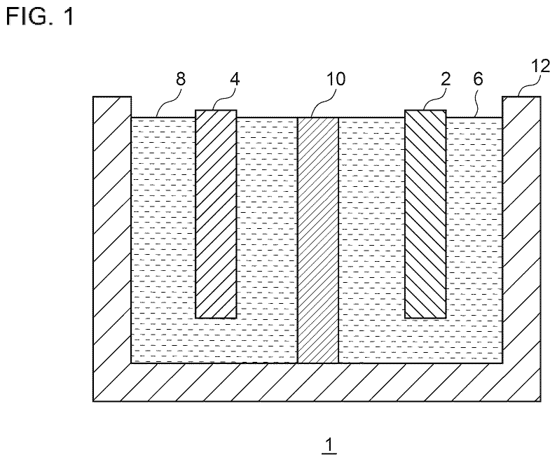

FIG. 1 is a schematic diagram of a power storage device 1 according to an embodiment. The power storage device 1 according to the present embodiment includes a positive electrode 2, a negative electrode 4, a positive electrolyte 6, a negative electrolyte 8, an anion exchange membrane 10, and a container 12. As an example, the power storage device 1 is a secondary battery. The power storage device 1 is not limited to an H-type cell shown in FIG. 1 and may be of a so-called coin cell type in which, for example, a laminate of the positive electrode 2 impregnated with the positive electrolyte 6, the anion exchange membrane 10, and the negative electrode 4 impregnated with the negative electrolyte 8 are housed in a coin-shaped container 12.

The positive electrode 2 contains manganese dioxide. For example, the positive electrode 2 has a structure in which a current collector is filled with a positive electrode mixture in which manganese dioxide, an electron conductive material, and a binder are mixed. Known manganese dioxide can be used for the manganese dioxide, and examples thereof include electrolytic manganese dioxide (EMD), and the like, for example. A known electron conductive material can be used for the electron conductive material, and examples thereof include carbon black such as acetylene black (AB), and the like, for example. A known binder can be used for the binder, and examples thereof include polymers such as polyvinylidene fluoride (PVDF), and the like, for example. The mass ratio of each material in the positive electrode mixture can be set appropriately. A known current collector can be used for the current collector, and examples thereof include porous metals, conductive meshes, conductive expanded meshes, conductive foams, and the like, for example.

Preferably, the positive electrode 2 further includes at least one element or ion selected from the group consisting of bismuth (trivalent), magnesium (divalent), calcium (divalent), strontium (divalent), barium (divalent), cerium (trivalent), nickel (divalent), cobalt (trivalent), and a quaternary ammonium ion. For example, by adding bismuth oxide (Bi₂O₃) to the positive electrode mixture, bismuth (trivalent) is contained in the positive electrode 2.

When the positive electrode 2 contains bismuth (trivalent), it is possible to suppress the formation of a Mn₃O₄ spinel structure at the positive electrode 2 during discharge. The Mn₃O₄ spinel structure is electrochemically less active. Therefore, by suppressing the formation of the Mn₃O₄ spinel structure, the reversible charge/discharge reaction can be maintained for a longer period of time. Therefore, the cycle characteristic of the power storage device 1 can be improved. Other elements and quaternary ammonium ions described above other than bismuth (trivalent) are also suitable as additives to the positive electrode 2 since the elements and quaternary ammonium ions can form layered compounds that stabilize the positive electrode structure.

Preferably, the positive electrode 2 further includes at least one element selected from the group consisting of copper (divalent), vanadium (pentavalent), chromium (hexavalent), iron (divalent), cobalt (divalent), selenium (tetravalent), ruthenium (tetravalent), rhodium (divalent), rhodium (trivalent), palladium (divalent), tin (tetravalent), antimony (pentavalent), osmium (tetravalent), and lead (divalent). For example, by immersing the positive electrode mixture in an aqueous copper sulfate solution, copper (divalent) is contained in the positive electrode 2.

Manganese, which is a positive electrode active material, contributes to the reaction of the power storage device 1 by a redox reaction of manganese (divalent)/(trivalent) and a redox reaction of manganese (trivalent)/(tetravalent). The redox potentials at this time are −0.6 V vs. Hg/HgO and +0.1 V vs. Hg/HgO, respectively. The redox reaction in which copper (divalent) is reduced to copper (zero valent) is in the potential region in which manganese (divalent) is oxidized to manganese (tetravalent) as described above. For this reason, copper (divalent) acts as a mediator for the positive electrode active material and reduces the charge/discharge overvoltage. Thereby, the capacity of the power storage device 1 can be improved. Other elements described above other than copper (divalent) are also suitable as additives to the positive electrode 2 since the same effect can be expected. The positive electrode 2 may include only one of an additive contributing to structural stabilization such as bismuth and an additive acting as a mediator such as copper (divalent) or both.

The negative electrode 4 contains zinc. Known members can be used for members constituting the negative electrode 4, and examples thereof include a zinc plate, and the like, for example. The positive electrode 2 and the negative electrode 4 are connected to an external circuit (not shown).

The positive electrolyte 6 is arranged so as to be in contact with the positive electrode 2. As an example, the positive electrode 2 is immersed in the positive electrolyte 6. A known electrolyte can be used as the positive electrolyte 6, and examples thereof include an aqueous solution of potassium hydroxide (KOH) and the like, for example.

The negative electrolyte 8 is arranged so as to be in contact with the negative electrode 4. As an example, the negative electrode 4 is immersed in the negative electrolyte 8. A known electrolyte can be used for the negative electrolyte 8, and examples thereof include an aqueous solution of potassium hydroxide containing zinc oxide (ZnO), and the like, for example.

The anion exchange membrane 10 separates the positive electrode 2 and the positive electrolyte 6 from the negative electrode 4 and the negative electrolyte 8. Therefore, the positive electrode 2 and the positive electrolyte 6 are arranged on one side and the negative electrode 4 and the negative electrolyte 8 are arranged on the other side with the anion exchange membrane 10 in between. The anion exchange membrane 10 suppresses zinc ions eluting from the negative electrode 4 to the negative electrolyte 8 moving to the positive electrode 2 side due to the discharge reaction of the power storage device 1. Thereby, manganese dioxide of the positive electrode 2 can be suppressed from taking up zinc ions and changing to have a ZnMn₂O₄ spinel structure. The ZnMn₂O₄ spinel structure is electrochemically inert. Therefore, by inhibiting the transfer of zinc ions to the positive electrode 2 side and consequently the formation of the ZnMn₂O₄ spinel structure, the reversible charge/discharge reaction can be maintained for a longer period of time. Therefore, the cycle characteristic of the power storage device 1 can be improved.

A known anion exchange membrane can be used for the anion exchange membrane 10, and examples thereof include FAAM-PK-75 (manufactured by FuMA-Tech), for example.

The anion exchange membrane 10 has a zin ion permeation rate per 24 hours of less than 15.6×10₋₆ [mol/cm²/24 hrs]. The zinc ion permeation rate in the anion exchange membrane 10 can be obtained, for example, by the following procedure. That is, the negative electrolyte 8 containing zinc ions and the positive electrolyte 6 not containing zinc ions are separated by the anion exchange membrane 10 and are left to stand for a predetermined time. Next, the concentration of zinc ions in the positive electrolyte 6 after the predetermined time has elapsed is measured. Then, the molar amount per unit time of zinc ions permeated to the positive electrolyte 6 side is calculated. Thereby, the zinc ion permeation rate can be obtained. As in the exemplary embodiment described later, when an exchange membrane laminate in which a plurality of anion exchange membranes 10 are stacked is used, the zin ion permeation rate in the exchange membrane laminate corresponds to “zinc ion permeation rate in the anion exchange membrane.” That is, the zinc ion permeation rate in the exchange membrane laminate satisfies to be less than 15.6×10⁻⁶ [mol/cm²/24 hrs].

Further, the anion exchange membrane 10 has a membrane resistance Rs of less than 12.3 [Ω·cm²]. The membrane resistance Rs is the product of the ion transfer resistance value [2] in the membrane thickness direction and the effective membrane area A [cm²]. By setting the membrane resistance Rs of the anion exchange membrane 10 to be less than 12.3 [Ω·cm²], it is possible to reduce the inhibition of permeation of the active material necessary for the charge/discharge reaction by the anion exchange membrane 10 while suppressing the permeation of zinc ions. As in the case of the zinc ion permeation rate, the membrane resistance Rs in the exchange membrane laminate corresponds to “membrane resistance Rs in the anion exchange membrane” for the exchange membrane laminate.

The container 12 houses the positive electrode 2, the negative electrode 4, the positive electrolyte 6, the negative electrolyte 8, and the anion exchange membrane 10. A known container can be used for the container 12, and examples thereof include a Ni can, a Ni-plated steel plate, and the like, for example. As an example, the inside of the container 12 is divided into two spaces by the anion exchange membrane 10. Then, the positive electrode 2 and the positive electrolyte 6 are housed in one space, and the negative electrode 4 and the negative electrolyte 8 are housed in the other space.

Reactions that occur when the power storage device 1 is discharged are as follows:

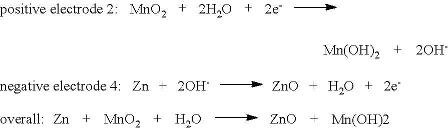

During charging of the power storage device 1, reactions occur in the direction opposite to that during discharging. In the present embodiment, hydroxide ions (OH⁻) act as active materials. During discharging, the hydroxide ions permeate the anion exchange membrane 10 from the positive electrode 2 side and move to the negative electrode 4 side. On the other hand, during charging, the hydroxide ions permeate the anion exchange membrane 10 from the negative electrode 4 side and move to the positive electrode 2 side. Hydroxide ions dissolved in the negative electrolyte 8 are subjected to the reaction at the negative electrode 4 that occurs during the first discharge. When the amount of hydroxide ions moving from the positive electrode 2 side to the negative electrode 4 side increases due to repeated charging and discharging, not only the hydroxide ions originally dissolved in the negative electrolyte 8 but also the hydroxide ions moved from the positive electrode 2 side are also subjected to reactions at the negative electrode 4. The same applies to the reaction that occurs during charging at the positive electrode 2.

The embodiments may be defined by the items described in the following.

### [Item 1]

A power storage device (1) including:
a positive electrode (2) containing manganese dioxide;
a negative electrode (4) containing zinc;
a positive electrolyte (6) in contact with the positive electrode (2);
a negative electrolyte (8) in contact with the negative electrode (4); and
an anion exchange membrane (10) that separates the positive electrode (2) and the positive electrolyte (6) from the negative electrode (4) and the negative electrolyte (8), wherein
the anion exchange membrane (10) has a zinc ion permeation rate of less than 15.6×10⁻⁶ [mol/cm²/24 hrs] and a membrane resistance of less than 12.3 [Ω·cm²].

### [Item 2]

The power storage device (1) according to Item 1, wherein
the positive electrode (2) further includes at least one element or ion selected from the group consisting of bismuth (trivalent), magnesium (divalent), calcium (divalent), strontium (divalent), barium (divalent), cerium (trivalent), nickel (divalent), cobalt (trivalent), and a quaternary ammonium ion.

### [Item 3]

The power storage device (1) according to Item 1 or Item 2, wherein
the positive electrode (2) further includes at least one element selected from the group consisting of copper (divalent), vanadium (pentavalent), chromium (hexavalent), iron (divalent), cobalt (divalent), selenium (tetravalent), ruthenium (tetravalent), rhodium (divalent), rhodium (trivalent), palladium (divalent), tin (tetravalent), antimony (pentavalent), osmium (tetravalent), and lead (divalent).

### EXEMPLARY EMBODIMENTS

Hereinafter, exemplary embodiments of the present invention will be explained. However, these exemplary embodiments are merely examples for suitably explaining the present invention and do not limit the present invention in any way.

### [Verification of Cycle Characteristics]

### First Exemplary Embodiment

An H-type cell was produced according to the following procedure. Specifically, a positive electrode mixture was produced by mixing EMD (manufactured by Tosoh Corporation), AB (manufactured by Denka Black), and PVDF (manufactured by Kureha Corporation). The mass ratio of the components in the positive electrode mixture was as follows: EMD:AB:PVDF=60:30:10. The obtained positive electrode mixture was filled into Ni foam (manufactured by Nilaco Corporation) so as to obtain a positive electrode (working electrode). In addition, a zinc plate (manufactured by Nilaco Corporation) was prepared as a negative electrode (counter electrode). Further, a mercury-mercury oxide (Hg/HgO) electrode was prepared as a reference electrode.

An anion exchange membrane FAAM-PK-75 (manufactured by FuMA-Tech, referred to as anion exchange membrane b) was inserted into the container, and the container was divided into two spaces. The effective area of the anion exchange membrane b was 3.14 cm², and the ion transfer resistance value in the membrane thickness direction was 1.1Ω. Then, 10 mL of 6 mol dm⁻³ KOH aqueous solution (manufactured by Nacalai Tesque, Inc.) was added as a positive electrolyte in one space, and a positive electrode was then inserted. Further, 10 mL of ZnO (manufactured by Nacalai Tesque, Inc.) saturated 6 mol dm⁻³ KOH aqueous solution (manufactured by Nacalai Tesque, Inc.) was added as a negative electrolyte in the other space, and a negative electrode was then inserted. Thereby, the H-type cell (power storage device) according to the first exemplary embodiment was obtained.

The electrochemical measurement of the H-type cell was performed using an electrochemical characterization device (SD8, manufactured by Hokuto Denko Corporation) and an ohmmeter (1260, manufactured by Solartron). In the electrochemical measurements, constant current charging and discharging was performed. Further, the current value was set to 30 mAg⁻¹, and the potential range was set to −0.6 to +0.3 V (vs. Hg/HgO).

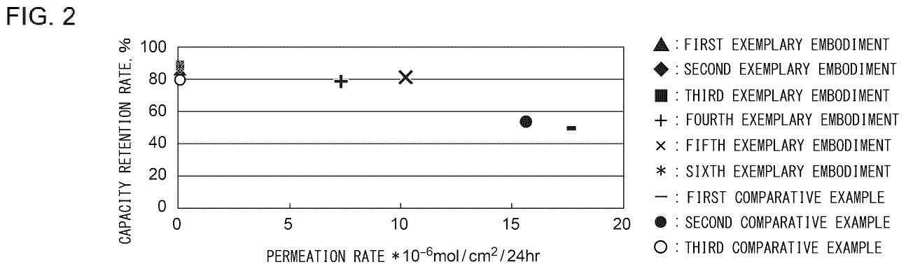

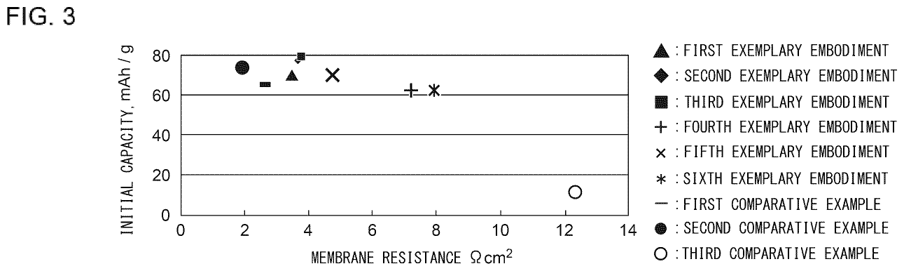

In addition, for the H-type cell according to the first exemplary embodiment, the diffusivity of zinc ions ([Zn(OH)₄]²⁻) through the anion exchange membrane under a static condition was examined. More specifically, the H-type cell was left to stand for 24 hours after being produced. Then, after 24 hours had elapsed, ICP measurement was performed on the positive electrolyte using an ICP optical emission spectrometer (iCAP7000, manufactured by Thermo Fisher Scientific Inc.), and zinc ions that had permeated to the positive electrode side through the anion exchange membrane were quantified. Further, the permeation rate was calculated from the amount of zinc ions that had permeated. The results of each measurement and calculation are shown in FIGS. 2 and 3.

### Second Exemplary Embodiment

The production of an H-type cell and electrochemical measurement were performed in the same manner as in the first exemplary embodiment except that Bi₂O₃ (manufactured by Kojundo Chemical) was added to the positive electrode mixture so as to obtain a positive electrode such that the mass ratio of the components in the positive electrode mixture was EMD:Bi₂O₃:AB:PVDF=54:6:30:10. The results are shown in FIGS. 2 and 3.

### Third Exemplary Embodiment

100 mL of 1 mol dm⁻³ copper sulfate aqueous solution (manufactured by Nacalai Tesque, Inc.) was added to 0.6 g of EMD (manufactured by Tosoh Corporation), and the mixture was stirred for 48 hours. The mixture was then suction-filtered. The filtered material was dried at 100° C. for four hours so as to produce a positive electrode material Cu-EMD. Then, The production of an H-type cell and electrochemical measurement were performed in the same manner as in the first exemplary embodiment except that Cu-EMD was used instead of EMD and that the mass ratio of the components in the positive electrode mixture was Cu-EMD:Bi₂O₃:AB:PVDF=54:6:30:10. The results are shown in FIGS. 2 and 3.

### Fourth Exemplary Embodiment

The production of an H-type cell, electrochemical measurement, and zinc ion permeation rate measurement were performed in the same manner as in the first exemplary embodiment except that a three-layered anion exchange membrane AHA (manufactured by ASTOM Corporation and referred to as anion exchange membrane a) was used instead of the anion exchange membrane b. The ion transfer resistance value in the membrane thickness direction of the three-layered anion exchange membrane a was 2.3Ω. The effective area is the same as that in the first exemplary embodiment. The results are shown in FIGS. 2 and 3.

### Fifth Exemplary Embodiment

The production of an H-type cell, electrochemical measurement, and zinc ion permeation rate measurement were performed in the same manner as in the first exemplary embodiment except that a two-layered anion exchange membrane a was used instead of the anion exchange membrane b. The ion transfer resistance value in the membrane thickness direction of the two-layered anion exchange membrane a was 1.5Ω. The effective area is the same as that in the first exemplary embodiment. The results are shown in FIGS. 2 and 3.

### Sixth Exemplary Embodiment

The production of an H-type cell, electrochemical measurement, and zinc ion permeation rate measurement were performed in the same manner as in the first exemplary embodiment except that a two-layered anion exchange membrane b was used. The ion transfer resistance value in the membrane thickness direction of the two-layered anion exchange membrane b was 2.5Ω. The effective area is the same as that in the first exemplary embodiment. The results are shown in FIGS. 2 and 3.

### First Comparative Example

The production of an H-type cell and electrochemical measurement were performed in the same manner as in the first exemplary embodiment except that a porous membrane (omnipore membrane filter, manufactured by Merck Millipore) was used instead of the anion exchange membrane b. The ion transfer resistance value in the membrane thickness direction of the porous membrane was 0.8Ω. The effective area is the same as that in the first exemplary embodiment. The results are shown in FIGS. 2 and 3.

### Second Comparative Example

The production of an H-type cell, electrochemical measurement, and zinc ion permeation rate measurement were performed in the same manner as in the first exemplary embodiment except that one anion exchange membrane a was used instead of the anion exchange membrane b. The ion transfer resistance value in the membrane thickness direction of the anion exchange membrane a was 0.6Ω. The effective area is the same as that in the first exemplary embodiment. The results are shown in FIGS. 2 and 3.

### Third Comparative Example

The production of an H-type cell, electrochemical measurement, and zinc ion permeation rate measurement were performed in the same manner as in the first exemplary embodiment except that a three-layered anion exchange membrane b was used. The ion transfer resistance value in the membrane thickness direction of the three-layered anion exchange membrane b was 3.9Ω. The effective area is the same as that in the first exemplary embodiment. The results are shown in FIGS. 2 and 3.

### [Electrochemical Measurement Results]

FIGS. 2 and 3 are diagrams showing results of electrochemical measurement of a power storage device according to each of exemplary embodiments and comparative examples. FIG. 2 shows the relationship between the zinc ion permeation rate and the capacity retention rate at the time when constant current charging and discharging is performed for ten cycles. FIG. 3 shows the relationship between the membrane resistance when using an anion exchange membrane or a porous membrane and the initial capacity of each H-type cell. “Membrane resistance” is the product of the ion transfer resistance value in the direction of membrane thickness and the effective membrane area in the produced power storage device. The “initial capacity” is the second discharge capacity in a charge/discharge test in which charging and discharging are repeated starting from discharging using a produced power storage device. The “capacity retention rate” is a ratio obtained by dividing the tenth discharge capacity by the initial discharge capacity when the aforementioned charge/discharge test is repeated ten times.

As shown in FIG. 2, the zinc ion permeation rate was 17.5×10⁻⁶ mol/cm²/24 hrs in the first comparative example where no anion exchange membrane was provided. Further, the zinc ion permeation rate was 15.6×10⁻⁶ mol/cm²/24 hrs in the second comparative example where one layer of anion exchange membrane a was provided. Therefore, the condition where the zinc ion permeation rate was less than 15.6×10⁻⁶ mol/cm²/24 hrs was not satisfied in the first and second comparative examples. In the first and second comparative examples, it was confirmed that the reversible capacity continued to decrease as the number of charging and discharging increased and that the capacity retention rate fell below 60% in ten charge/discharge cycles.

On the other hand, in the first to third exemplary embodiment where one layer of anion exchange membrane b was provided and the sixth exemplary embodiment where a two-layered anion exchange membrane b was provided, the zinc ion permeation rate was less than 15.6×10⁻⁶ mol/cm²/24 hrs, and specifically, 0.14×10⁻⁶ mol/cm²/24 hrs or less. Further, even in a case where the anion exchange membrane a was used, the zinc ion permeation rate was 7.3×10⁻⁶ mol/cm²/24 hrs in the fourth exemplary embodiment where a three-layered anion exchange membrane a was provided. Further, the zinc ion permeation rate was 10.2×10⁻⁶ mol/cm²/24 hrs in the fifth exemplary embodiment where a two-layered anion exchange membrane a was provided. In the first to sixth exemplary embodiments, it was confirmed that a decrease in the reversible capacity due to an increase in the number of charging and discharging was suppressed and that the capacity retention rate was about 80% or more in ten charge/discharge cycles. In the third comparative example where a three-layered anion exchange membrane b is provided, a high capacity retention rate was also confirmed just like that in the first to sixth exemplary embodiments due to the suppression of zinc ion permeation.

As shown in FIG. 3, compared to the first exemplary embodiment where Bi₂O₃ was not included in the positive electrode mixture, an increase in initial capacity was observed in the second and third exemplary embodiments where the positive electrode mixture contains Bi₂O₃. This is considered to be due to an increase in the redox potential of Mn²⁺ and Mn³⁺ caused due to the incorporation of Bi₂O₃ in the positive electrode, leading to an improvement in the utilization rate of the positive electrode active material in the power storage device. In the third exemplary embodiment where Cu was included in the positive electrode mixture, a further increase in the initial capacity was observed.

Further, in the sixth exemplary embodiment where a two-layered anion exchange membrane b was provided, the membrane resistance was 7.9 Ω·cm², and the initial capacity was obtained that was equivalent to that in the first exemplary embodiment where one layer of anion exchange membrane b was provided. On the other hand, in the third comparative example where a three-layered anion exchange membrane b was provided, the membrane resistance was 12.3 Ω·cm², and a significant decrease in the initial capacity was observed. Further, in the fourth exemplary embodiment where a three-layered anion exchange membrane a was provided, the membrane resistance was 7.2 Ω·cm², and the initial capacity was obtained that was equivalent to that in the first exemplary embodiment where one layer of anion exchange membrane b was provided.

Therefore, it has been confirmed that an anion exchange membrane can contribute to improving the performance of a power storage device when the zinc ion permeation rate under a static condition is less than 15.6×10⁻⁶ mol/cm²/24 hrs while the membrane resistance of the anion exchange membrane in the power storage device is less than 12.3 Ω·cm². It has been also confirmed that the zinc ion permeation rate is preferably 10.2×10⁻⁶ mol/cm²/24 hrs or less. Further, it has been confirmed that the membrane resistance was preferably 7.9 Ω·cm² or less.

### [Structural Analysis of Positive Electrode]

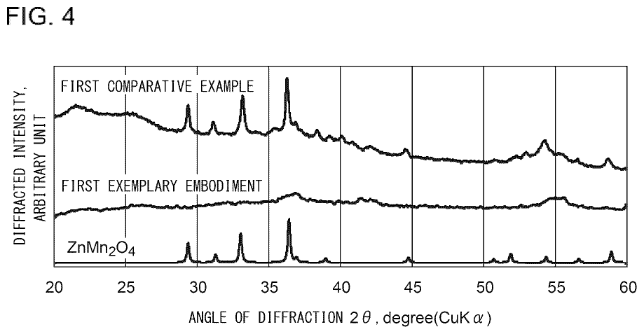

For the H-type cells according to the first exemplary embodiment and the first comparative example, XRD measurement was performed on the positive electrode after electrochemical measurement using an X-ray diffractometer (RINT-2200, manufactured by Rigaku Corporation). The results are shown in FIG. 4. FIG. 4 is a diagram showing results of structural analysis of a power storage device according to the first exemplary embodiment and the first comparative example. FIG. 4 also shows the analysis result of ZnMn₂O₄ spinel as a reference. As shown in FIG. 4, at the positive electrode in the first comparative example, a peak derived from ZnMn₂O₄ spinel was observed. On the other hand, at the positive electrode in the first exemplary embodiment, no peak derived from ZnMn₂O₄ spinel was observed. At the positive electrode in the first exemplary embodiment, only broad peaks (2θ=37°, 42°, 55°) derived from MnOOH were observed. From this, it has been confirmed that at least the anion exchange membrane b allows for suppression of irreversible changes in manganese dioxide.

1. A power storage device comprising:
a positive electrode containing manganese dioxide;
a negative electrode containing zinc;
a positive electrolyte in contact with the positive electrode;
a negative electrolyte in contact with the negative electrode; and
an anion exchange membrane that separates the positive electrode and the positive electrolyte from the negative electrode and the negative electrolyte, wherein
the anion exchange membrane has a zinc ion permeation rate of less than 15.6×10-6 [mol/cm2/24 hrs] and a membrane resistance of less than 12.3 [Ω·cm2].

2. The power storage device according to claim 1, wherein
the positive electrode further includes at least one element or ion selected from the group consisting of bismuth (trivalent), magnesium (divalent), calcium (divalent), strontium (divalent), barium (divalent), cerium (trivalent), nickel (divalent), cobalt (trivalent), and a quaternary ammonium ion.

3. The power storage device according to claim 1, wherein
the positive electrode further includes at least one element selected from the group consisting of copper (divalent), vanadium (pentavalent), chromium (hexavalent), iron (divalent), cobalt (divalent), selenium (tetravalent), ruthenium (tetravalent), rhodium (divalent), rhodium (trivalent), palladium (divalent), tin (tetravalent), antimony (pentavalent), osmium (tetravalent), and lead (divalent).
